(19) United States
(12) Patent Application Publication
(10) Pub. No.: US 2010/0181523 A1
(43) Pub. Date: Jul. 22, 2010

(54) CARBON DIOXIDE-BASED WORKING FLUIDS FOR REFRIGERATION AND AIR CONDITIONING SYSTEMS

(75) Inventors: Richard Kelley, Princeton, NJ (US); Dale Carr, Morristown, NJ (US); Jeffrey Hutter, Edison, NJ (US); Edward T. Hessell, Fairfield, CT (US)

Correspondence Address: Patent Coordinator;CHEMTURA CORPORATION, 199 Benson Rd., Middlebury, CT, 06749, US

(73) Assignee: Chemtura Corporation, Middlebury, CT (US)

(21) Appl. No.: 12/684,315

(22) Filed: Jan. 8, 2010

Related U.S. Application Data
(60) Provisional application No. 61/145,290, filed on Jan. 16, 2009.

(51) Int. Cl. C09K 5/04

(52) U.S. Cl. 252/67

(57) ABSTRACT

A working fluid comprising (a) a refrigerant comprising carbon dioxide and (b) a poly(neopentylpolyol)ester composition produced by reacting a neopentylpolyol having the formula:

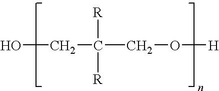

wherein each R is independently selected from the group consisting of CH₃, C₂H₅ and CH₂OH and n is a number from 1 to 4, with at least one monocarboxylic acid having 2 to 15 carbon atoms in the presence of an acid catalyst and at a mole ratio of carboxyl groups to hydroxyl groups of less than 1:1 to form a partially esterified composition. The partially esterified poly(neopentyl)polyol composition is then reacted with additional monocarboxylic acid having 2 to 15 carbon atoms to form a final poly(neopentylpolyol)ester composition.

### CROSS REFERENCE TO RELATED APPLICATIONS

This application claims the benefit of the filing date of U.S. Provisional Application No. 61/145,290 filed Jan. 16, 2009, the entire contents of which are incorporated herein by reference.

### FIELD

This invention relates to carbon dioxide-based working fluids for refrigeration and air conditioning systems.

### BACKGROUND

Carbon dioxide has been used as a working fluid for refrigeration systems as early as at the beginning of modern cryo-engineering. In fact, Linde built the first compression refrigerating machine in 1881 using carbon dioxide as the working fluid. Up to the middle of this century, carbon dioxide was used mainly in ship refrigeration equipment with sub-critical process controls. Glycerine was used as a lubricant. More recently, following the introduction of fluorochlorohydrocarbon refrigerants, carbon dioxide has been largely replaced.

However, carbon dioxide still offers advantages as a working fluid for refrigeration and air conditioning systems, particularly those operating in a trans-critical cyclic process. However, the operating pressures required for such systems are considerably higher than in most present day refrigeration systems. Moreover, in a trans-critical cyclic process, the operating medium is present both in the sub-critical and in the super-critical state, which results in unique lubrication problems. On the one hand, almost complete miscibility between the lubricating oil and CO₂ is required at temperatures as low −40° C. On the other hand, corresponding lubrication and stability properties need to be guaranteed under the influence of CO₂ at pressures of up to 150 bar and temperatures of up to 220° C. In air conditioning equipment, in particular, the lubricating oil is subject to extreme mechanical and thermal stresses. Tribological difficulties occur in test compressors of the most varied types of design.

In the tribological contact areas subject to the influence of CO₂, special conditions are present. At the moment of start up and shut down, in particular, strong solubility-dependent effects occur which inhibit the formation of a sufficient lubrication film, allowing the oil film to be readily washed out as a result of factors such as pressure equalization and changes in surface tension. Wear measurements on prototype compressors of different design have shown, however, that the dilution and degasification effects described can be compensated for only to some extent by using correspondingly highly viscous oils. In this respect, sufficient oil recycling from the evaporator is not always guaranteed. In addition, the higher viscosity oil leads to loss of energy efficiency and almost always a decrease in low temperature flow properties. Moreover, investigations carried out with piston compressors operated at sub-critical level have indicated that, in spite of a sufficiently high mixture viscosity, an unusually high stress is present in the area where mixed friction is present.

From a purely tribological point of view, the solubility of CO₂ in the lubricant should be as low as possible at any given temperature and pressure of operation to minimize viscosity reduction of the lubricant leading to a decrease in lubricity and load carrying ability of the lubricant/CO₂ solution. On the other hand, a satisfactory miscibility is required for oil recycling and for heat transfer in the cold cycle.

As a result, only certain chemical compounds exhibit the necessary properties to be useful as lubricants for refrigeration systems using carbon dioxide as the heat transfer agent or working fluid. Examples of such necessary properties include good low temperature flow properties, excellent lubricity and load carrying ability and miscibility with carbon dioxide over the total temperature range of operation of the equipment. As a result of the comparatively high volumetric refrigeration output of CO₂ and its increased efficiency, cryogenic compressors can be dimensioned smaller for carbon dioxide. This requires a high load carrying capacity of the lubricant in the corresponding temperature range. Investigations have shown that the physical properties and the interactions between different basic oils and sub-critical and super-critical CO₂ depend to a large extent on their chemical composition. For example, mineral oils are almost immiscible with CO₂ and exhibit only moderate high temperature stability, making them largely unsuitable for use as lubricants with CO₂-based working fluids. Because of their unfavorable phase behaviour and their comparatively low density, hydrocracked oils, alkyl aromatics and polyalphaolefins (PAO) must be classified as unsuitable for use in systems with a battery on the intake side. In addition, polyalkylene glycols have been used with carbon dioxide but cannot be used in systems having an internal motor (as for instance, in the air conditioning systems of hybrid automobiles) because of poor resistivity.

Polyol esters (POEs) are well known in the art as lubricants for displacement type refrigeration systems. Commonly used commercial POEs are derived from the reaction of a polyol (an alcohol containing 2 or more OH groups) with a monofunctional carboxylic acid. The physical characteristics of simple polyol esters are primarily derived from the structure of the acid component. Because there are a wide variety of commercially available carboxylic acids, simple polyol esters can be designed with specific physical characteristics that are optimized for a particular refrigeration system application. But for simple polyol esters there are limits to the simultaneous optimization of all desired properties. For instance, the lubricity and load carrying ability of a polyol ester lubricant is improved by using longer chain linear acids rather than shorter chain and/or branched alkyl groups. But the exact opposite may be true for miscibility with the refrigerant. So there is a careful balance required to optimize both the lubricity and load carrying ability of the lubricant with the miscibility of the lubricant and refrigerant over the widest possible temperature range of operation. In addition, the negative impact on lubricity and load carrying ability of the lubricant will become more pronounced as refrigeration system manufacturers move to lower viscosity lubricants to improve energy efficiency.

Polyol esters are especially suited for use in systems utilizing hydrofluorocarbon refrigerants (HFCs), such as R-134a and related molecules, because their polar nature provides improved miscibility with the refrigerant in comparison to other lubricants such as mineral oils, poly-alpha-olefins, or alkylated aromatics. One example of such a polyol ester lubricant is disclosed in U.S. Pat. No. 6,221,272.

Polyol esters have also been proposed for use as lubricants with CO₂-based working fluids, but to date these proposals have generally required the presence of additives to improve the high temperature properties of the ester lubricant. For example, U.S. Pat. No. 7,303,693 discloses that polyalkylene glycols and/or neopentyl polyol esters, when combined with alkylated triaryl phosphate esters, are suitable for lubricating refrigerators, air-conditioning systems, heat pumps and similar systems which are operated using carbon dioxide as an operating medium. The neopentyl polyol esters are formed by reaction of neopentyl polyols, such as neopentyl glycol, pentaerythritol and trimethylol propane, with linear or branched C4 to C12 monocarboxylic acids. Preferred neopentyl polyols are said to include pentaerythritol and/or dipentaerythritol (DPE) and/or tripentaerythritol (TPE), especially mixtures comprising predominantly dipentaerythritol.

U.S. Pat. No. 6,692,654 discloses a fluid composition for a refrigerating machine which comprises a refrigerating machine oil comprising a refrigerant containing carbon dioxide, an ester oil and a stabilizer in the form of a glycidyl ester epoxy compound. Suitable ester oils include esters of a diol or a polyol having 3 to 20 hydroxyl groups and a fatty acid having 6 to 20 carbon atoms. Preferred polyols are hindered alcohols such as neopentyl glycol, trimethylol ethane, trimethylol propane, trimethylol butane, di-(trimethylol propane), tri-(trimethylol propane), penthaerythritol, di-(pentaerythritol) and tri-(penthaerythritol).

However, while additives are known to assist in improving the properties of polyol esters, it is also generally accepted that their use should be minimized as they can either precipitate out from the lubricant at low temperatures (as are encountered in the evaporator) or decompose to insoluble by-products at very high temperatures (as are experienced in the compressor). Such “drop out” of the additives from the lubricant can often lead to deposits on, or complete blockage of, the refrigeration system expansion device (thermal expansion valve, capillary, or needle valve) leading to a decrease in refrigeration performance or complete failure of the system, respectively. There is also the risk that the anti-wear/extreme pressure additives (usually highly functional organic molecules containing heteroatoms) will react with the carbon dioxide refrigerant.

There is a need for an improved polyol ester lubricant for carbon dioxide-based refrigeration systems where the lubricant, preferably without the inclusion of separate additive, possesses complete miscibility with carbon dioxide over a wide temperature range of operation while also maintaining adequate lubricity and load carrying ability, provides protection against wear of refrigeration components and in addition improves the energy efficiency of the refrigeration system as compared to working fluids containing existing polyol ester lubricants.

According to the present invention, it has now been found that certain poly(neopentyl polyol)esters produced as described in U.S. Pat. Nos. 3,670,013 and 5,895,778 exhibit a unique combination of improved low temperature flow properties and improved high temperature dynamic viscosity when used as lubricants with carbon dioxide-based working fluids. The poly(neopentyl polyol) esters also exhibit good miscibility with carbon dioxide over the total temperature range of operation of typical carbon dioxide refrigeration systems. Neither of U.S. Pat. Nos. 3,670,013 and 5,895,778 disclose or suggest the use of these esters with carbon dioxide refrigerants.

### SUMMARY

In one aspect, the invention resides in a working fluid comprising (a) a refrigerant comprising carbon dioxide and (b) a poly(neopentylpolyol)ester composition produced by:

(i) reacting a neopentylpolyol having the formula:

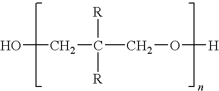

wherein each R is independently selected from the group consisting of CH₃, C₂H₅ and CH₂OH and n is a number from 1 to 4, with at least one monocarboxylic acid having 2 to 15 carbon atoms in the presence of an acid catalyst and at a mole ratio of carboxyl groups to hydroxyl groups of less than 1:1 to form a partially esterified composition; and

(ii) reacting the partially esterified poly(neopentyl)polyol composition produced in (i) with additional monocarboxylic acid having 2 to 15 carbon atoms to form a final poly(neopentylpolyol)ester composition.

Conveniently, said reacting (i) is conducted at a mole ratio of carboxyl groups to hydroxyl groups of about 1:4 to 1:2.

Conveniently, said neopentylpolyol has the formula:

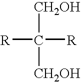

wherein each of R is independently selected from the group consisting of CH₃, C₂H₅ and CH₂OH. In one embodiment, said neopentylpolyol comprises pentaerythritol.

Conveniently, said at least one monocarboxylic acid has 5 to 11 carbon atoms, such as 6 to 10 carbon atoms. Generally, said at least one monocarboxylic acid comprises at least one linear monocarboxylic acid, such as n-pentanoic, n-heptanoic acid, n-octanoic, n-nonanoic, n-decanoic, or a mixture thereof. In one embodiment, said at least one monocarboxylic acid comprises between about 15 and about 100 mole percent heptanoic acid and between about 85 and 0 mole percent of n-octanoic acid and/or n-decanoic acid.

In a further aspect, the invention resides in a working fluid comprising (a) a refrigerant comprising carbon dioxide and (b) a polyol ester composition comprising:

(i) about 45 to 55 wt % of an ester of monopentaerythritol with at least one monocarboxylic acid having 2 to 15 carbon atoms;

(ii) less than 13 wt % of an ester of dipentaerythritol with at least one monocarboxylic acid having 2 to 15 carbon atoms;

(iii) less than 10 wt % of an ester of tripentaerythritol with at least one monocarboxylic acid having 2 to 15 carbon atoms; and

(iv) at least 25 wt % of an ester of tetrapentaerythritol and higher pentaerythritol oligomers with at least one monocarboxylic acid having 2 to 15 carbon atoms.

### BRIEF DESCRIPTION OF THE DRAWINGS

FIG. 1 is a Daniel Plot (graph of kinematic viscosity against temperature) for a working fluid comprising carbon dioxide and the polyneopentylpolyol ester of Example 1.

FIG. 2 is a Daniel Plot for a working fluid comprising carbon dioxide and the polyol ester of Example 2.

FIG. 3 is a graph of kinematic viscosity at 0° C. against carbon dioxide concentration for carbon dioxide working fluids comprising (a) the polyneopentylpolyol ester of Example 1 and (b) the polyol ester of Example 2.

FIG. 4 is a graph of kinematic viscosity at 100° C. against carbon dioxide concentration for carbon dioxide working fluids comprising (a) the polyneopentylpolyol ester of Example 1 and (b) the polyol ester of Example 2.

### DETAILED DESCRIPTION OF THE EMBODIMENTS

Described herein is a working fluid for a refrigeration and/or an air conditioning system wherein the working fluid employs carbon dioxide as a refrigerant and a poly(neopentylpolyol)ester composition as a lubricant. The ester composition is produced by reacting a neopentylpolyol with at least one monocarboxylic acid having 2 to 15 carbon atoms in a multi-stage process such that there is molar excess of hydroxyl groups in a first acid-catalyzed esterification stage and additional monocarboxylic acid is added to a second stage to complete the esterification process. The resultant ester composition is found to be soluble in the refrigerant over a broad temperature range to produce a working fluid having excellent low temperature flow properties and high temperature dynamic viscosity.

### Neopentylpolyol

The neopentylpolyol employed to produce the present ester lubricant composition has the general formula:

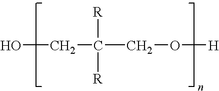

wherein each of R is independently selected from the group consisting of CH₃, C₂H₅ and CH₂OH; and n is a number from 1 to 4. In one preferred embodiment, n is one and the neopentylpolyol has the formula:

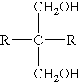

wherein each of R is as defined above.

Non-limiting examples of suitable neopentylpolyols include pentaerythritol, dipentaerythritol, tripentaerythritol, tetrapentaerythritol, trimethylolpropane, trimethylolethane, neopentyl glycol and the like. In some embodiments, a single neopentylpolyol is used to produce the ester lubricant, whereas in other embodiments two or more such neopentylpolyols are employed. For example, one commercially available grade of pentaerythritol contains small amounts of dipentaerythritol, tripentaerythritol, and possibly tetrapentaerythritol.

### Monocarboxylic Acid

The at least one monocarboxylic acid employed to produce the polyol ester composition has from about 2 to about 15 carbon atoms for example from about 5 to about 11 carbon atoms, such as from about 6 to about 10 carbon atoms. Typically the acid obeys the general formula:

R¹C(O)OH

wherein R¹ is a C₁ to C₁₂ alkyl, aryl, aralkyl or alkaryl group, such as a C₄ to C₁₀ alkyl group, for example C₅ to C₉ alkyl group. The alkyl chain R¹ may be branched or linear depending on the requirements for viscosity, viscosity index and degree of miscibility of the resulting lubricant with the refrigerant. In practice it is possible to use blends of different monobasic acids to achieve the optimum properties in the final lubricant.

Examples of suitable monocarboxylic acids include saturated, linear monocarboxylic acids, especially C₄ to C₁₀ linear monocarboxylic acids, such as butanoic acid, pentanoic acid, hexanoic acid, heptanoic acid, octanoic acid, nonanoic acid, decanoic acid and mixtures thereof; saturated, branched monocarboxylic acids, especially C₅ to C₁₀ branched monocarboxylic acids, such as the branched C5 acids (3-methylbutanoic acid and 2-methylbutanoic acid), the branched C7 acids (such as 2,4-dimethylpentanoic acid), the branched C8 acids (such as 2-ethylhexanoic acid), and the branched C9 acids (such as 3,3,5-trimethylhexanoic acid); as well as aromatic monocarboxylic acids, such as benzoic acid. Preferred monocarboxylic acids include linear monocarboxylic acids, such as n-pentanoic, n-heptanoic acid, n-octanoic, n-nonanoic, n-decanoic, and mixtures thereof.

In one embodiment, the monocarboxylic acid is n-heptanoic acid or a mixture of n-heptanoic acid with a further linear monocarboxylic acid, especially n-octanoic acid and/or n-decanoic acid. Such an acid mixture typically contains between about 15 and about 100 mole percent heptanoic acid and between about 85 and 0 mole percent of the further linear monocarboxylic acid. In a preferred embodiment, the mixture comprises between about 75 and 100 mole percent heptanoic acid and between about 25 and 0 mole percent of a 3:2 molar mixture of octanoic and decanoic acids.

### Production of the Poly(Neopentylpolyol)Ester Composition

The poly(neopentylpolyol)ester composition employed in the present working fluid is formed by a two step process, as described in U.S. Pat. Nos. 3,670,013 and 5,895,778, the entire disclosures of which are incorporated herein by reference.

In the first step, a neopentylpolyol as defined above and a C₂ to C₁₅ monocarboxylic acid or acid mixture are charged to a reaction vessel such that the mole ratio of carboxyl groups to hydroxyl groups is less than 1:1, and typically is from about 1:4 to about 1:2. Also charged to the reaction vessel is at least one acid catalyst, which typically is a strong acid catalyst, that is an acid having a pKa less than 1. Examples of suitable acid catalysts include mineral acids, preferably, sulfuric acid, hydrochloric acid, and the like, acid salts such as, for example, sodium bisulfate, sodium bisulfite, and the like, sulfonic acids such as, for example, benzenesulfonic acid, toluenesulfonic acid, polystyrene sulfonic acid, methylsulfonic acid, ethylsulfonic acid, and the like.

The reaction mixture is then heated to a temperature of between about 150° C. and about 250° C., typically between about 170° C. and about 200° C., while acid vapor and water vapor are continuously removed from the reaction vessel, generally by the application of a vacuum source. The carboxylic acid, but not the water, removed during this step of the reaction is returned to the reactor and the reaction is continued until the desired quantity of water is removed from the reaction mixture. This can be determined by experimentation or may be estimated by calculating the expected amount of water of reaction. At this point when the starting neopentylpolyol is pentaerythritol, the mixture includes partial esters of pentaerythritol, dipentaerythritol, tripentaerythritol, tetrapentaerythritol and higher oligomeric/polymeric polyneopentylpolyols. Optionally, the acid catalyst may be neutralized with alkali at the end of the first reaction stage.

In order to complete the esterification of the partial esters, an excess of a C₂ to C₁₅ monocarboxylic acid or acid mixture acid or acid mixture and optionally an esterification catalyst is added to the reaction mixture. The additional acid can be the same or a different C₂ to C₁₅ monocarboxylic acid or acid mixture used in the initial step and is generally added in amount to provide a 10 to 25 percent excess of carboxyl groups, with respect to hydroxyl groups. The reaction mixture is then reheated to a temperature of between about 200° C. and about 260° C., typically between about 230° C. and about 245° C., with water of reaction removed being removed from the reaction vessel and acid being returned to the reactor. The use of vacuum will facilitate the reaction. When the hydroxyl value is reduced to a sufficiently low level, typically less than 1.0 mg KOH/g, the bulk of the excess acid is removed by vacuum distillation. Any residual acidity is neutralized with an alkali and the resulting poly(neopentylpolyol)ester is recovered and dried.

The resultant ester may be used without further purification or may be purified using conventional techniques such as distillation, treatment with acid scavengers to remove trace acidity, treatment with moisture scavengers to remove moisture and/or filtration to improve clarity.

### Composition and Properties of the Polyester

The composition of the poly(neopentylpolyol)ester will depend on the particular neopentylpolyol and monocarboxylic acid employed to produce the ester but, where the neopentylpolyol is pentaerythritol, the ester will typically have the following composition:

(i) about 45 to 55 wt % of an ester of monopentaerythritol with at least one monocarboxylic acid having 2 to 15 carbon atoms;

(ii) less than 13 wt % of an ester of dipentaerythritol with at least one monocarboxylic acid having 2 to 15 carbon atoms;

(iii) less than 10 wt % of an ester of tripentaerythritol with at least one monocarboxylic acid having 2 to 15 carbon atoms; and

(iv) at least 25 wt % of an ester of tetrapentaerythritol and higher pentaerythritol oligomers with at least one monocarboxylic acid having 2 to 15 carbon atoms.

The polyol esters produced herein exhibit an advantageous combination of high viscosity index, excellent miscibility with a carbon dioxide refrigerant over a broad temperature range of about −10° C. to about 120° C., and good wear resistance and load-carrying ability.

### Working Fluid

The present polyol esters are particularly intended for use as lubricants in working fluids for refrigeration and air conditioning systems, wherein the heat transfer fluid is carbon dioxide, either alone or in admixture with a hydrocarbon, a hydrofluorocarbon and/or a fluorocarbon.

The hydrocarbon refrigerants may be those which are gaseous at 25° C. and one atmospheric pressure. Specific examples of the hydrocarbon refrigerants are alkanes, cycloalkanes and alkenes each having 1 to 5 carbon atoms, preferably 1 to 4 carbon atoms, such as methane, ethylene, ethane, propylene, propane, cyclopropane, butane, isobutane, cyclobutane, methylcyclopropane and a mixture of at least two kinds thereof.

Non-limiting examples of suitable fluorocarbon and hydrofluorocarbon compounds include carbon tetrafluoride (R-14), difluoromethane (R-32), 1,1,1,2-tetrafluoroethane (R-134a), 1,1,2,2-tetrafluoroethane (R-134), pentafluoroethane (R-125), 1,1,1-trifluoroethane (R-143a) and tetrafluoropropene (R-1234yf). Non-limiting examples of mixtures of hydrofluorocarbons, fluorocarbons, and/or hydrocarbons include R-404A (a mixture of 1,1,1-trifluoroethane, 1,1,1,2-tetrafluoroethane and pentafluoroethane), R-410A (a mixture of 50 wt % difluoromethane and 50 wt % pentafluoroethane), R-410B (a mixture of 45 wt % difluoromethane and 55 wt % pentafluoroethane), R-417A (a mixture of 1,1,1,2-tetrafluoroethane, pentafluoroethane and n-butane), R-422D (a mixture of 1,1,1,2-tetrafluoroethane, pentafluoroethane and iso-butane), R-427A (a mixture of difluoromethane, pentafluoroethane, 1,1,1-trifluoroethane and 1,1,1,2-tetrafluoroethane) and R-507 (a mixture of pentafluoroethane and 1,1,1-trifluoroethane).

The blending ratio of carbon dioxide to hydrocarbon/hydrofluorocarbon and/or fluorocarbon refrigerant is not particularly restricted. The total amount of hydrocarbon/hydrofluorocarbon and/or fluorocarbon may be within the range of preferably 1 to 200 parts by weight, more preferably 10 to 100 parts by weight per 100 parts by weight of carbon dioxide.

The mixing ratio of the polyol ester lubricant to the refrigerant is also not particularly restricted, but the lubricant may be present in a ratio of 1 to 500 parts by weight, more preferably 2 to 400 parts by weight per 100 parts by weight of the refrigerant.

A working fluid containing the polyol ester described above as the base oil may further contain mineral oils and/or synthetic oils such as poly-α-olefins, alkylbenzenes, esters other than those described above, polyethers, polyvinyl ethers, perfluoropolyethers, phosphoric acid esters and/or mixtures thereof.

In addition, it is possible to add to the working fluid conventional lubricant additives, such as antioxidants, extreme-pressure additives, antiwear additives, friction reducing additives, defoaming agents, profoaming agents, metal deactivators, acid scavengers and the like.

Examples of the antioxidants that can be used include phenolic antioxidants such as 2,6-di-t-butyl-4-methylphenol and 4,4′-methylenebis(2,6-di-t-butylphenol); amine antioxidants such as p,p-dioctylphenylamine, monooctyldiphenylamine, phenothiazine, 3,7-dioctylphenothiazine, phenyl-1-naphthylamine, phenyl-2-naphthylamine, alkylphenyl-1-naphthylamine, and alkylphenyl-2-naphthylamine; sulfur-containing antioxidants such as alkyl disulfide, thiodipropionic acid esters and benzothiazole; and zinc dialkyl dithiophosphate and zinc diaryl dithiophosphate.

Examples of the extreme-pressure additives, antiwear additives, friction reducing additives that can be used include zinc compounds such as zinc dialkyl dithiophosphate and zinc diaryl dithiophosphate; sulfur compounds such as thiodipropionic acid esters, dialkyl sulfide, dibenzyl sulfide, dialkyl polysulfide, alkylmercaptan, dibenzothiophene and 2,2′-dithiobis(benzothiazole); sulfur/nitrogen ashless antiwear additives such as dialkyldimercaptothiadiazoles and methylenebis(N,N-dialkyldithiocarbamates); phosphorus compounds such as triaryl phosphates such as tricresyl phosphate and trialkyl phosphates; dialkyl or diaryl phosphates; trialkyl or triaryl phosphites; amine salts of alkyl and dialkylphosphoric acid esters such as the dodecylamine salt of dimethylphosphoric acid ester; dialkyl or diaryl phosphites; monoalkyl or monoaryl phosphites; fluorine compounds such as perfluoroalkyl polyethers, trifluorochloroethylene polymers and graphite fluoride; silicon compounds such as a fatty acid-modified silicone; molybdenum disulfide, graphite, and the like. Examples of organic friction modifiers include long chain fatty amines and glycerol esters.

Examples of the defoaming and profoaming agents that can be used include silicone oils such as dimethylpolysiloxane and organosilicates such as diethyl silicate. Examples of the metal deactivators that can be used include benzotriazole, tolyltriazole, alizarin, quinizarin and mercaptobenzothiazole. Furthermore, epoxy compounds such as phenyl glycidyl ethers, alkyl glycidyl ethers, alkylglycidyl esters, epoxystearic acid esters and epoxidized vegetable oil, organotin compounds and boron compounds may be added as acid scavengers or stabilizers.

Examples of moisture scavengers include trialkylorthoformates such as trimethylorthoformate and triethylorthoformate, ketals such as 1,3-dioxacyclopentane, and amino ketals such as 2,2-dialkyloxazolidines.

The working fluids comprising the present polyol esters and a refrigerant can be used in a wide variety of refrigeration and heat energy transfer applications. Non-limiting examples include all ranges of air conditioning equipment from small window air conditioners, centralized home air conditioning units to light industrial air conditioners and large industrial units for factories, office buildings, apartment buildings and warehouses. Refrigeration applications include small home appliances such as home refrigerators, freezers, water coolers, vending machines and icemakers to large scale refrigerated warehouses and ice skating rinks. Also included in industrial applications would be cascade grocery store refrigeration and freezer systems. Heat energy transfer applications include heat pumps for house hold heating and hot water heaters. Transportation related applications include automotive and truck air conditioning, refrigerated semi-trailers as well as refrigerated marine and rail shipping containers.

Types of compressors useful for the above applications can be classified into two broad categories; positive displacement and dynamic compressors. Positive displacement compressors increase refrigerant vapor pressure by reducing the volume of the compression chamber through work applied to the compressor's mechanism. Positive displacement compressors include many styles of compressors currently in use, such as reciprocating, rotary (rolling piston, rotary vane, single screw, twin screw), and orbital (scroll or trochoidal). Dynamic compressors increase refrigerant vapor pressure by continuous transfer of kinetic energy from the rotating member to the vapor, followed by conversion of this energy into a pressure rise. Centrifugal compressors function based on these principles. Details of the design and function of these compressors for refrigeration applications can be found in the 2008 ASHRAE Handbook, HVAC systems and Equipment, Chapter 37; the contents of which are included in its entirety by reference.

The invention will now be more particularly described with reference to the following Examples.

In the preparative Examples, the reactor was equipped with a mechanical stirrer, thermocouple, thermoregulator, Dean Stark trap, condenser, nitrogen sparger, and vacuum source.

As used herein, the term “acid value” of a polyol ester composition refers to the amount of unreacted acid in the composition and is reported as amount in mg of potassium hydroxide required to neutralize the unreacted acid in 1 gram of the composition. The acid value is measured by ASTM D 974.

### Example 1

To a reactor as described above was charged 392 grams pentaerythritol (2.88 moles), 720 grams n-heptanoic acid (5.54 moles) and a strong acid catalyst as described by Leibfried in U.S. Pat. No. 3,670,013. The initial charge has a mole ratio of carboxyl groups to hydroxyl groups of 1:2.08 and the expected water of esterification from the initial charge is 5.54 moles or about 100 grams.

The mixture was heated to a temperature of about 170° C. and water of reaction was removed and collected in the trap. Vacuum was applied at temperature to obtain a reflux thereby removing the water and returning the acid collected in the trap to the reactor. The temperature was maintained at 170° C. under vacuum until 125 ml of water was collected. At this point the reaction mixture consisted of partial esters of pentaerythritol, dipentaerythritol, tripentaerythritol, tetrapentaerythritol, and higher oligomer esters of pentaerythritol.

After cooling the partially esterified product to about 134° C., an additional 236.6 grams (1.82 moles) of n-heptanoic acid was added, along with 264.4 grams (2.05 moles) of a 6:4 blend of n-octanoic:n-decanoic acids and an amount of alkali sufficient to neutralize the strong acid catalyst used in the first step. Heat was then applied to raise the temperature of the reaction mixture to 240° C., whereafter the mixture was maintained at this temperature for about 8 hours. At this time a total of 173 ml water has been collected and the hydroxyl value was 6.4 mg KOH/g.

The reaction mixture was then held at 240° C. for about 3 additional hours, with vacuum being applied to remove excess acid overhead. When the acid value was less than 1.0 mg KOH/g, the mixture was cooled to 80° C. and residual acidity was neutralized with alkali. The viscosity at 40° C. was 140 cSt and at 100° C. was 19.6 cSt. Approximately 275 grams of a technical pentaerythritol ester of n-heptanoic, n-octanoic acid and n-decanoic acid was added to dilute the product to a target viscosity grade of ISO 68 and the product was dried and filtered. The physical properties of the resultant product are provided in Table 1.

### Example 2 (Comparative)

Comparative Example 2 is a polyol ester based synthetic refrigeration lubricant commercially available from CPI Engineering Services under the trade name Emkarate RL 68H. The base stock of Emkarate RL 68H is an ester of monopentaerythritol with a mixture of branched and linear C₅ to C₉ carboxylic acids. The physical properties of the ester of Comparative Example 2 are provided in Table 1.

TABLE 1

| | Example 1 | | |
|---|---|---|---|
| | Polyneopentyl | Comparative | |
| Property | polyol | Example 2 | Method |
| Kinematic Viscosity | 68.6 | 65.5 | ASTM D-445 |
| @ 40° C. | | | |
| Kinematic Viscosity | 10.9 | 9.5 | ASTM D-445 |
| @ 100° C. | | | |
| Viscosity Index | 150 | 117 | ASTM D-2270 |
| TAN, mg KOH/g | 0.02 | 0.02 | ASTM D-664 |
| Water Content, ppm | 25 | <40 | ASTM D-1533, |
| | | | Method B |
| Density @ 15.6° C., | 8.23 | 8.12 | ASTM D-4052 |
| lbs/gal | | | |
| Pour Point, ° C. | −46 | −39 | ASTM D-97 |
| Flash Point, ° C. | 279 | 270 | ASTM D-92 |
| ASTM Color | <1.0 | Not reported | ASTM D-1500 |

### Example 3

The esters of Examples 1 and 2 were compared in four different wear and load carrying bench tests as described below and the results are summarized in Table 2.

### a) ASTM D 4172 4-Ball Wear Test

This test measures the wear preventive properties of a lubricant under boundary lubrication conditions. Four ball wear tests were conducted according to ASTM method D 4172 using a Falex Variable Drive Four-Ball Wear Test Machine. In the test, four balls are arranged in an equilateral tetrahedron, with the lower three balls being clamped securely in a test cup filled with lubricant and the upper ball being held by a chuck that is motor-driven. The upper ball rotates against the fixed lower balls. Load is applied in an upward direction with a pneumatic loading system which also has an air bearing to allow free movement of the sample cup for measurement of coefficient of friction if desired. Heaters allow operation at elevated oil temperatures. The three stationary steel balls are immersed in 10 milliliters of sample to be tested, and the fourth steel ball is rotated on top of the three stationary balls in “point-to-point contact.” The machine is operated for one hour at 75° C. with a load of 40 kilograms and a rotational speed of 1,200 revolutions per minute. At the end of the test the average diameter of the wear scars on the three lower balls is measured and reported in millimeters.

### b) ASTM D 3233 Method A, Pin-On-Vee Block Test

This test measures the extreme pressure load carrying performance of the lubricant. A steel journal held in place by a brass shear pin is rotated against two stationary V-blocks to give a four-line contact. The test pieces and their supporting jaws are immersed in the oil sample cup for oil lubricants. T he journal is driven at 250 rpm and load is applied to the V-blocks through a nutcracker action lever arm and spring gage. The load is actuated and ramped continuously during the test by means of a ratchet wheel mechanism. The load is ramped by the loading ratchet mechanism until the brass shear pin shears or the test pin breaks. The torque is reported in pounds from the gauge attached to the Falex lubricant tester.

### c) Cameron-Plint Reciprocating Wear Test

The anti-wear properties of the esters of Examples 1 and 2 were also evaluated using the Cameron-Plint TE77 High Frequency Friction Machine Tester. The specimen parts (6 mm diameter AISI 52100 steel ball of 800±20 kg/mm² hardness and hardened ground NSOH B01 gauge plate of RC 60/0.4 micron) were rinsed and then sonicated for 15 minutes with technical grade hexanes. This procedure was repeated with isopropyl alcohol. The specimens were dried with nitrogen and set into the TE77 tester. The oil bath was filled with 10 mL of sample. The test was run at a 30 Hertz frequency, 100 Newton load, 2.35 mm amplitude. The test starts with the specimens and oil at room temperature Immediately, the temperature was ramped over 15 minutes to 50° C., where it was then held constant for 15 minutes. The temperature was then ramped over 15 minutes to 100° C., where it was held constant for 45 minutes. A third temperature ramp over 15 minutes to 150° C. was followed by a final dwell at 150° C. for 15 minutes. The total length of the test was 2 hours. At the end of test, the wear scar diameter on the 6 mm ball was measured using a Leica StereoZoom6^{R} Stereomicroscope and a Mitutoyo 164 series Digimatic Head. Also determined was the maximum depth of the wear scar on the plate (Wear Scar Depth, μm). This was measured using a profilimeter.

### d) ASTM D 2783 Four-Ball Extreme Pressure Test

This test is similar to the anti-wear test (a) above, but starts at room temperature and the load on the four rotating balls is constantly increased until the balls weld to each other. The quantities measured to assess performance are weld point load (kgf), scar diameter (mm at 100 kgf or 126 kgf) just before weld point, and load wear index (LWI) (average of sum of the corrected loads determined for 10 applied loads preceding the weld point, kgf). A higher LWI is an indication of better anti-wear properties.

TABLE 2

| | Example 1 | |
|---|---|---|
| | Polyneopentyl | Comparative |
| Test | polyol ester | Example 2 |
| ASTM D-4172 | 0.88 | 0.67 |
| 4-Ball Wear Test, | | |
| average wear scar, mm | | |
| ASTM D-3233 Method A | 1250 | 900 |
| Falex Pin and V-block, | | |
| lbs to break | | |
| Cameron-Plint Wear Test | 0.72 (29.2) | 0.78 (31.7) |
| Ball scar width | | |
| (plate scar depth) | | |
| ASTM D 2783 4-Ball EP | 53.3/160/50 | 37.8/126/40 |
| Test LWI/Weld Point/Last | | |
| Non-seizure Load | | |

### Example 4

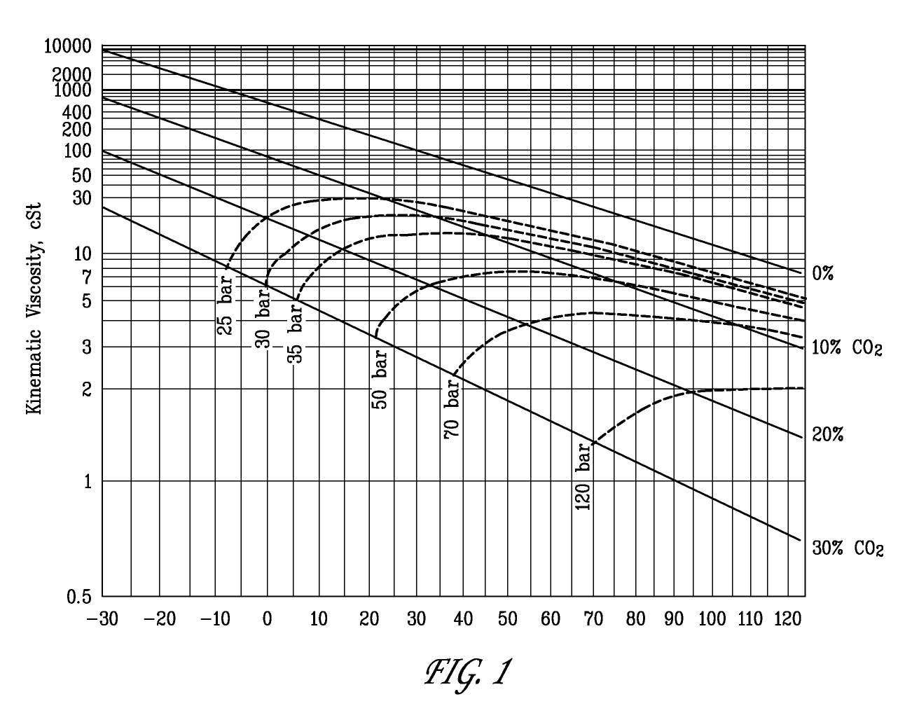

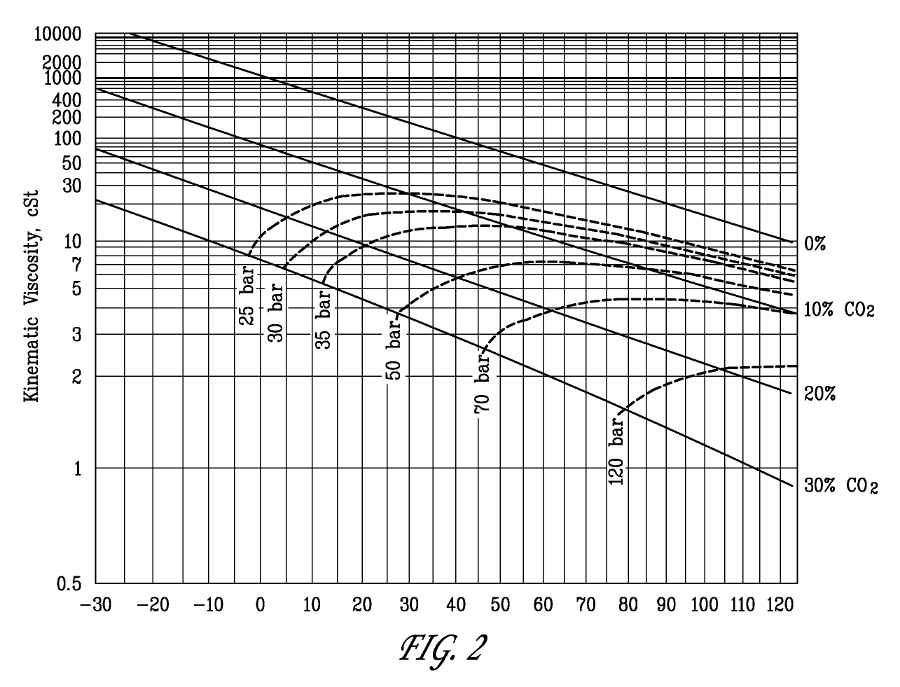

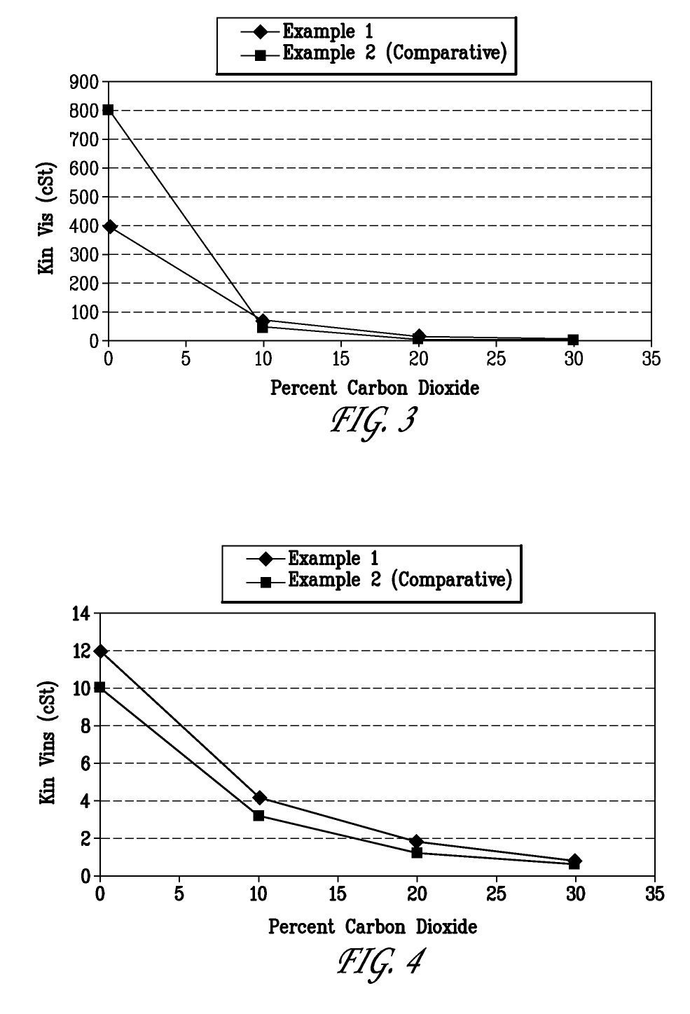

The pressure-viscosity-temperature relationship data shown in FIG. 1 for combinations of the lubricant of the invention with carbon dioxide (R-744) was generated using the equipment and method described by Seeton, C. J. and Hrnjak, P. in “Thermophysical Properties of CO₂-Lubricant Mixtures and Their Affect on 2-Phase Flow in Small Channel”; presented at the International Refrigeration and Air Conditioning Conference, July 17-20, paper number R-170. Corresponding data for Comparative Example 2 in combination with carbon dioxide was also acquired and is reported in FIG. 2. Select data from both experiments are reported in Table 3, FIG. 3 and FIG. 4.

TABLE 3

| | Example 1 | |
|---|---|---|
| | Polyneopentyl | Comparative |
| Conditions | polyol ester | Example 2 |
| 110° C. and 120 Bar | | |
| % Carbon Dioxide | 17 | 19 |
| Kinematic Viscosity (cSt) | 2.0 | 1.4 |
| 110° C. and 50 Bar | | |
| % Carbon Dioxide | 6.5 | 8.0 |
| Kinematic Viscosity (cSt) | 4.7 | 3.2 |

The data reported in Table 3 demonstrate that, although both lubricants are compatible with carbon dioxide, carbon dioxide has a lower steady state concentration at both 50 and 120 bar in the lubricant of the invention (Example 1). This results in less viscosity dilution by carbon dioxide giving a working fluid with a higher kinematic viscosity at any given pressure and temperature combination. The higher viscosity of the working fluid results in improved lubricity and load carrying ability as compared with the working fluid containing the lubricant of Comparative Example 2.

The results reported in FIG. 3 demonstrate that, as compared with the lubricant of Comparative Example 2, the lubricant of Example 1 alone has a lower kinematic viscosity at 0° C., which is important for energy conservation during start up, but a comparable viscosity at any given concentration of carbon dioxide (i.e., there is less viscosity loss due to dilution with carbon dioxide).

The results reported in FIG. 4 support the data presented in Table 3 and demonstrate that at high temperature the viscosity of the refrigerant/lubricant combination of Example 1 is always higher than that for the refrigerant/lubricant combination of Comparative Example 2. This again is important for maintenance of good lubricity and load carrying of the working fluid during high temperature operation of the compressor.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A working fluid comprising (a) a refrigerant comprising carbon dioxide and (b) a poly(neopentylpolyol)ester composition produced by:
(i) reacting a neopentylpolyol having the formula: 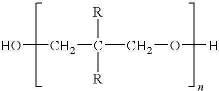
wherein each R is independently selected from the group consisting of CH₃, C₂H₅ and CH₂OH and n is a number from 1 to 4, with at least one monocarboxylic acid having 2 to 15 carbon atoms in the presence of an acid catalyst and at a mole ratio of carboxyl groups to hydroxyl groups of less than 1:1 to form a partially esterified composition; and
(ii) reacting the partially esterified poly(neopentyl)polyol composition produced in (i) with additional monocarboxylic acid having 2 to 15 carbon atoms to form a final poly(neopentylpolyol)ester composition.

2. The working fluid of claim 1, wherein said reacting (i) is conducted at a mole ratio of carboxyl groups to hydroxyl groups of about 1:4 to about 1:2.

3. The working fluid of claim 1, wherein said neopentylpolyol has the formula: 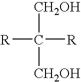
wherein each of R is independently selected from the group consisting of CH₃, C₂H₅ and CH₂OH.

4. The working fluid of claim 1, wherein said neopentylpolyol is selected from pentaerythritol, dipentaerythritol, tripentaerythritol, tetrapentaerythritol, trimethylolpropane, trimethylolethane, neopentyl glycol and mixtures thereof.

5. The working fluid of claim 1, wherein said neopentylpolyol comprises pentaerythritol.

6. The working fluid of claim 1, wherein said at least one monocarboxylic acid has 5 to 11 carbon atoms.

7. The working fluid of claim 1, wherein said at least one monocarboxylic acid has 6 to 10 carbon atoms.

8. The working fluid of claim 1, wherein said at least one monocarboxylic acid is selected from acetic acid, propionic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, 3-methylbutanoic acid, 2-methylbutanoic acid, 2-ethylhexanoic acid, 2,4-dimethylpentanoic acid, 3,3,5-trimethylhexanoic acid, benzoic acid and mixtures thereof.

9. The working fluid of claim 1, wherein said at least one monocarboxylic acid comprises at least one linear monocarboxylic acid.

10. The working fluid of claim 9, wherein said at least one linear monocarboxylic acid is selected from n-pentanoic, n-heptanoic acid, n-octanoic, n-nonanoic, n-decanoic, and mixtures thereof.

11. The working fluid of claim 1, wherein said at least one monocarboxylic acid comprises between about 15 and about 100 mole percent heptanoic acid and between about 85 and about 0 mole percent of n-octanoic acid and/or n-decanoic acid.

12. The working fluid of claim 1, wherein said reacting (i) is conducted at a temperature of about 170° C. to about 200° C.

13. The working fluid of claim 1, wherein the refrigerant further comprises at least one of a hydrocarbon, a hydrofluorocarbon and a fluorocarbon.

14. A working fluid comprising (a) a refrigerant comprising carbon dioxide and (b) a polyol ester composition comprising:
(i) about 45 to about 55 wt % of an ester of monopentaerythritol with at least one monocarboxylic acid having 2 to 15 carbon atoms;
(ii) less than 13 wt % of an ester of dipentaerythritol with at least one monocarboxylic acid having 2 to 15 carbon atoms;
(iii) less than 10 wt % of an ester of tripentaerythritol with at least one monocarboxylic acid having 2 to 15 carbon atoms; and
(iv) at least 25 wt % of an ester of tetrapentaerythritol and higher pentaerythritol oligomers with at least one monocarboxylic acid having 2 to 15 carbon atoms.

15. The working fluid of claim 14, wherein said at least one monocarboxylic acid has 5 to 11 carbon atoms.

16. The working fluid of claim 14, wherein said at least one monocarboxylic acid has 6 to 10 carbon atoms.

17. The working fluid of claim 14, wherein said at least one monocarboxylic acid comprises at least one linear monocarboxylic acid.

18. The working fluid of claim 14, wherein said at least one linear monocarboxylic acid is selected from n-pentanoic, n-heptanoic acid, n-octanoic, n-nonanoic, n-decanoic, and mixtures thereof.

19. The working fluid of claim 14, wherein said at least one monocarboxylic acid comprises between about 15 and about 100 mole percent heptanoic acid and between about 85 and 0 mole percent of n-octanoic acid and/or n-decanoic acid.

20. The working fluid of claim 14, wherein the refrigerant further comprises at least one of a hydrocarbon, a hydrofluorocarbon and a fluorocarbon.
